(19) United States
(12) Patent Application Publication
(10) Pub. No.: US 2012/0196708 A1
(43) Pub. Date: Aug. 2, 2012

(54) ARROW TRACKING DEVICE, METHOD AND COMPUTER-READABLE MEDIUM THEREOF

(76) Inventor: Larry C. Maddox, Birmingham, AL (US)

(21) Appl. No.: 13/362,618

(22) Filed: Jan. 31, 2012

Related U.S. Application Data
(60) Provisional application No. 61/457,211, filed on Jan. 31, 2011.

(51) Int. Cl. F42B 6/04; G01S 13/88; F42B 12/36

(52) U.S. Cl. 473/570; 473/578; 473/586; 342/176

(57) ABSTRACT

Disclosed is an arrow tracking device, method and computer-readable medium related to tracking an arrow. In particular, the arrow device may have a tip, a shaft and an end. The arrow device may have a tracker embedded within the shaft. A current position of the arrow device may be located and displayed by transmitting arrow information from the arrow to a computer or portable device having a processor. Arrow information including location data and historical data may be obtained from the device in combination with the computer or portable device. Other embodiments are also described.

### CROSS-REFERENCE TO RELATED APPLICATIONS

This application is related to and claims the benefit of priority to Provisional Application U.S. Ser. No. 61/457,211, Attorney Docket No. 2139.1001 P, entitled ARROW TRACKING DEVICE, METHOD AND COMPUTER-READABLE MEDIUM THEREOF, by Larry C. Maddox, filed Jan. 31, 2011 in the U.S. Patent and Trademark Office, the contents of which are incorporated herein by reference.

### BACKGROUND

1. Field

One or more embodiments relate to an arrow tracking device, method and computer-readable medium thereof, more particularly to an arrow tracking device within a shaft of an arrow thereby allowing the arrow to be more easily located after being shot from a bow.

2. Description of the Related Art

Tracking devices may be used to observe object movement. One example of a tracking device is a Global Positioning System (GPS). A GPS is a satellite-based navigation system which includes 24 satellites which were originally placed into orbit by the United States Department of Defense. Since the early 1980s, GPS has been made available for civilian use and GPS devices have proliferated and are included in many consumer devices such as vehicle navigation systems and portable devices including cell phones. Meanwhile, GPS receivers capable of receiving data from the GPS have gradually become smaller. A GPS receiver triangulates its current position by comparing a time that a signal is transmitted from GPS satellites until it is received by a receiver on Earth. A typical GPS receiver locks on to the signal of at least three satellites to receive a two-dimensional position on the earth (latitude and longitude) and that locks on to the signal of four or more satellites to determine a three-dimensional position on the earth (latitude, longitude and altitude).

Typical arrows used for hunting and fishing game may be difficult to locate after being shot. As an example, a fisherman may shoot the arrow from a crossbow or a regular compound bow a great distance. The bow may include a fishing reel which is mounted thereon. When the arrow is shot from the bow, line flows out from a containment unit attached to the arrow. However, after being shot from the bow, an exact location of the arrow may be difficult to determine. Additionally, if the line breaks, then the arrow may be very difficult to locate and retrieve and could become lost. Unfortunately, fisherman must expend a great deal of time and energy when the locating such an arrow.

This and other problems related to losing arrows shot from bows is solved by adding an arrow tracking device to a conventional arrow.

### SUMMARY

The foregoing and/or other aspects are achieved by providing an arrow tracking device having a tip, a shaft and an end. The shaft of the arrow tracking device includes a tracker embedded therein to track a position of an arrow.

Additional aspects, features, and/or advantages of exemplary embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the exemplary embodiments, taken in conjunction with the accompanying drawings of which:

FIG. 1 shows a side-view of an arrow tracking device, according to an example embodiment.

FIG. 2 is a close-up view of components of a tracker, included in an arrow tracking device, according to an example embodiment.

FIG. 3 shows a computer which may be used to locate an arrow tracking device, according to an example embodiment.

FIG. 4 shows a view of an arrow at a particular location on a map, according to an example embodiment.

FIG. 5 shows a view of a user locating an arrow tracking device using a portable handheld device, according to an example embodiment.

FIG. 6 shows a side-view of an arrow tracking device, according to an example embodiment.

FIG. 7 shows a side-view of an arrow tracking device, according to an example embodiment.

FIG. 8 shows a side-view of an arrow tracking device, according to an example embodiment.

FIG. 9 shows a side-view of an arrow tracking device, according to an example embodiment.

FIG. 10 shows a side-view of an arrow tracking device, according to an example embodiment.

FIG. 11 shows a side-view of an arrow tracking device, according to an example embodiment.

FIG. 12 shows a side-view of an arrow tracking device, according to an example embodiment.

FIG. 13 illustrates a block diagram of a method to capture and store arrow information, according to an example embodiment.

### DETAILED DESCRIPTION

The foregoing and/or other aspects are achieved by providing an arrow tracking device having a screw-on tip, a shaft, at least one set of barbs, and an end having fletches. The arrow tracking device includes a tracker embedded within the shaft of the arrow. By including the tracker within the arrow tracking device, an arrow may be more easily located after it is shot from a bow. In one embodiment, the tracker may be a global positioning system (GPS). Furthermore, the GPS may include a GPS receiver, a GPS transmitter, and a battery powering the GPS receiver and the GPS transmitter.

The foregoing and/or other aspects are achieved by receiving arrow information, by a computer or portable device having a processor. Arrow information may include location data and/or historical data. The location data may include a plurality of locations, one of which may be a current location, of an arrow obtained via at least one tracker device, embedded in an arrow. The computer may store the plurality of locations of the arrow in a storage. The computer or portable device may capture and store the location data transmitted from the tracker. The computer may then display the current location of the arrow on a display of the computer or portable device.

Additionally, the computer or portable device may also capture and store historical data. Historical data may include data pertaining to a use of the arrow at a particular point in time. The location data may be used in combination with the historical data to populate fields relating to entry of the historical data. The computer or portable device may use the historical data and the location data to recount a particular hunting event.

The foregoing and/or other aspects may be achieved by providing at least one computer readable medium storing a program which may cause a computer or portable device having a processor to receive location data and/or historical data. The computer readable medium includes computer readable instructions to direct at least one processor to implement methods of one or more embodiments.

Reference will now be made in detail to exemplary embodiments, examples of which are illustrated in the accompanying drawings, wherein like reference numerals refer to like elements throughout. Exemplary embodiments are described below to explain the present disclosure by referring to the figures.

Example embodiments relate to arrow tracking devices, methods and computer-readable mediums thereof.

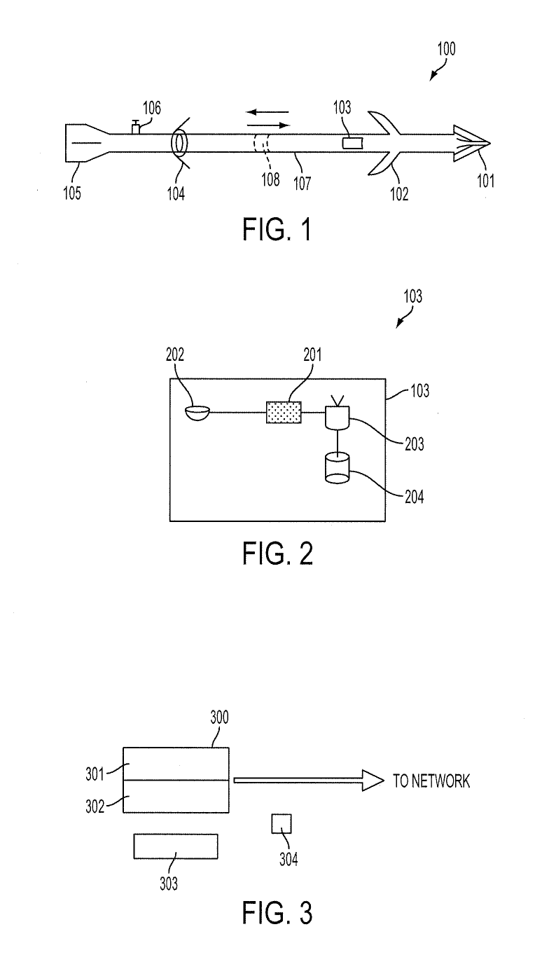

FIG. 1 illustrates a side-view of an arrow tracking device 100 according to an example embodiment. Referring to FIG. 1, the arrow tracking device 100 includes a screw-on head 101, connected to a hollow shaft 107 and positioned on the outside of one end of the arrow tracking device 100. The screw-on head 101 may be detachable from the hollow shaft 107 of the arrow tracking device 100. This may allow for interchangeability of the screw-on head 101 depending on a given hunting purpose. Further, the screw-on head 101 may be any pointed projectile formed from, among other things, metal, horn, stone, synthetic plastic, rubber, or any other hard material. In one embodiment, the screw-on head 101 may be, for example, a replaceable Trocar™ tip.

In an exemplary embodiment, the arrow tracking device 100 may include a tracker 103 which may be positioned at one end of the hollow shaft 107, close to the screw-on-head 101. In alternative, embodiments, the tracker 100 may be positioned in other parts of the hollow shaft 107. In an exemplary embodiment, the tracker 103 may be embedded within the hollow shaft 107 of the arrow tracking device 100. This provides a benefit of limiting the effect the tracker 103 may have on flight of an arrow. The tracker 103 may be embedded into the hollow shaft 107 of the arrow tracking device 100 by an arrow manufacturer. This may help ensure proper weighting and calibration of the arrow tracking device 100 containing the tracker 103. In an exemplary embodiment, the tracker 103 may be any device capable of transmitting a wireless signal. One example of a tracker 103 may be a GPS chip or GPS transmitter. In another embodiment, the tracker 103 may be a radio pulse device. The radio pulse device may be any device which uses radio waves to determine a location, range, altitude, direction and/or speed of an object. In yet another embodiment, the tracker 103 may be a GSM/GPRS tracking device.

In another exemplary embodiment, the arrow tracking device 100 may further include a first set of metal barbs 102. The first set of metal barbs 102 may be positioned between the screw-on head 101 and the tracker 103. If the arrow tracking device 100 fractures or breaks, it is possible the tracker 103 may separate from the hollow shaft 107. The first set of metal barbs 102 may be positioned immediately in front of the tracker 103 to help prevent splintering of an arrow upon impact. Further, the first set of metal barbs 102 may be retractable for safety purposes. Before a hunter is ready to use the arrow tracking device 100, the first set of metal barbs 102 may be positioned for use, increasing the effectiveness of the arrow tracking device 100 in contacting a hunting target. In one embodiment, the first set of metal barbs 102 may be wrapped around the hollow shaft 107 of the arrow tracking device 100. This may further minimize splintering or fracturing of the arrow tracking device 100.

The arrow tracking device 100 may further include a second set of metal barbs 104 which may be located on a sliding ring (not shown) encircling the hollow shaft 107. The arrow tracking device 100 may further include fletches 105 which may assist the arrow tracking device 100 while in flight. The arrow tracking device 100 may also include a screw 106, which may act as a stopper. The second set of metal barbs 104 may slide along the hollow shaft 107 of the arrow tracking device 100 via the sliding ring and stop when reaching the screw 106 at one end of the arrow tracking device 100 and stop when reaching the first set of metal barbs 102 at the opposite side of the arrow tracking device 100. The screw-on head 101 coupled with the first and second set of metal barbs 102 and 104, respectively, may act together to catch and penetrate the flesh of game, such as a fish.

The hollow shaft 107 of the arrow tracking device 100 may be fashioned of any material that is flexible yet sturdy. The material of the hollow shaft 107 may also be weather resistant and water-proof. Materials of the hollow shaft 107 may include but are not limited to lightweight wood, bamboo, reeds, aluminum, stainless steel, fiberglass, carbon fiber reinforced polymer, plastics or composite materials including an aluminum core wrapped with a carbon fiber exterior.

A user may shoot the arrow tracking device of the present embodiments from any type of bow device, including but not limited to a crossbow, a regular compound bow, or mechanical bow device. The arrow tracking device 100 may vary in length depending on the type of bow used. For example, an arrow tracking device 100 used by a crossbow may be between eighteen and twenty-two inches, whereas an arrow tracking device 100 used by a regular compound bow may be longer (i.e. twenty to thirty-five inches). The bow device may be calibrated and tuned for optimal use. In one embodiment the bow device may be laminated. Other embodiments of a bow device may also include a center shot and working recurves.

In an alternative embodiment, the arrow tracking device 100 may be adjustable in length to fit different bow devices. Part of the hollow shaft 107 may be adjusted to allow the arrow tracking device 100 to fit different bow devices. The hollow shaft 107 may be lockable/unlockable using a locking mechanism 108. A user may unlock the locking mechanism 108 by twisting the hollow shaft 107, and reconfigure the length of the arrow tracking device 100 by sliding the hollow shaft 107 into a desired length. The locking mechanism 108 may be locked by the user by again twisting the hollow shaft 107, preparing the arrow tracking device 100 for use. In one embodiment, a part of the hollow shaft 107 containing the tracker 103 may not be adjustable so as to not affect or damage the tracker 103. The bow also may also include a reel. When the arrow tracking device 100 is shot from the bow, line flows out from a containment unit attached to the arrow tracking device 100. After being shot from the bow, a location of the arrow tracking device 100 may be determined using the tracker 103.

FIG. 2 is a close-up view of components which may be included within the tracker 103 of an arrow tracking device, according to an example embodiment. Referring to FIG. 2, the tracker 103 may include a GPS receiver 201 which may fit into a printed circuit board, a battery 202 (which may be, for example, a lithium ion battery), a GPS transmitter 203 and a storage 204. After the GPS receiver 201 obtains a clear signal from GPS satellites (not shown), the GPS transmitter 203 may transmit its location to a server, computer (not shown) or portable device having a processor (not shown) which is connected to a network, for example, the internet. The GPS device 201 may also store a location which is obtained by the receiver 201 in the storage 204. The GPS transmitter 203 may be either a pull device or a push device. If the GPS transmitter 203 is a push device, then the location may be pushed or sent at regular intervals of time to the server or computer. If the GPS transmitter 203 is a pull device, then the location may be pulled from another device or computer which requests the location at a particular time.

The battery 202, details of which are beyond the scope of the example embodiments, may be of the type that requires infrequent changing, for example, every three days. Example embodiments may also include a lithium ion battery which may be charged by solar power.

FIG. 3 illustrates a computer 300 or similar device which may be used to locate an arrow tracking device, according to an example embodiment. The computer may include a display 301, a CPU 302, and input devices 303 and 304. The computer may be connected to a network, for example, the internet. Using this connection to the network, computer 300 may receive location data including a location of the arrow tracking device 100 and store the location in a storage 305 (not shown). The computer 300 may store locations of the arrow over a period of time and generate a time-lapse view of locations of the arrow tracking device 100 to be displayed on display 301. In the event that a user needs to locate an arrow, the user may use the input devices 303 and 304 to request that the computer 300 indicate the current location of an arrow stored in the storage 305 and display the current location of the arrow tracking device 100 on a map.

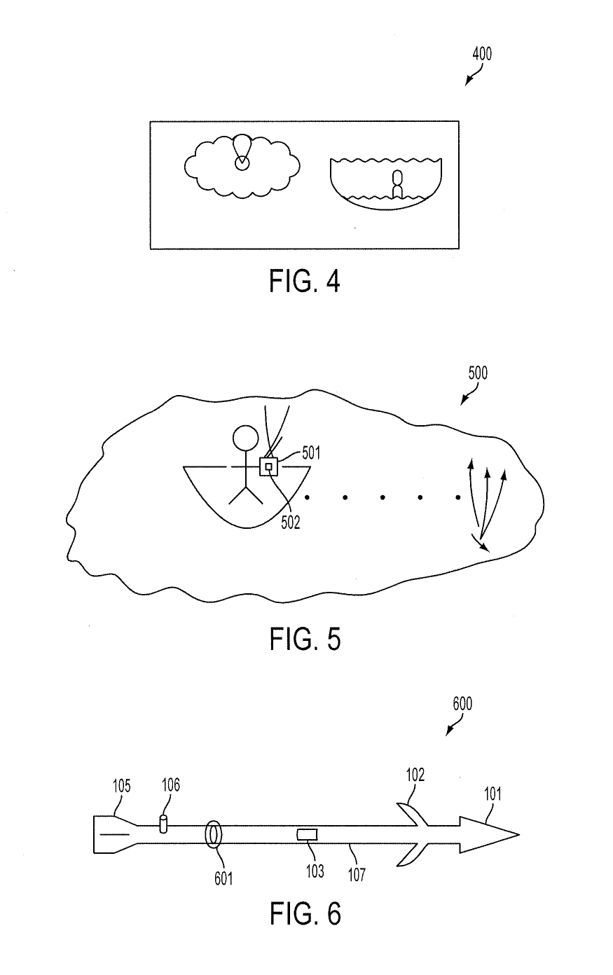

FIG. 4 shows a view of an arrow at a particular location on a map, according to an example embodiment. The arrow may be an arrow tracking device such as the arrow tracking device 100 described in FIG. 1. An example of a map 400 showing a current location of the arrow is shown in FIG. 4. The current location may be obtained by a computer which accesses the location data. The current location may include a latitude, longitude and altitude of the arrow and the tracker transmits the received location data over a network to a computer.

The computer may also display a time-lapse view of positions of the arrow based on a predetermined starting time. In one embodiment, the computer may also display a current underwater depth of the arrow and underwater environmental surroundings of the arrow. In another embodiment, the computer may also provide a distance and directions from a current location of the computer or user to the current location of the arrow so that the arrow may be retrieved.

FIG. 5 illustrates a view 500 of a user locating an arrow tracking device using a handheld portable device, according to an example embodiment. In one embodiment, the handheld portable device 501 may have components included, for example, in FIG. 3. The handheld portable device 501 may be any mobile device having a processor and wireless capability. Examples of common handheld portable devices 501 include but are not limited to smartphones, wireless pad/tablet devices, personal digital assistant (PDA) devices, laptops, digital pen devices, carputers, and ultra mobile personal computers, among others. By using a handheld portable device 501 having its own tracker receiver, 502, a user may locate the current position of an arrow tracking device such as the arrow tracking device 100 described in FIG. 1, responsive to a current location of the user.

FIG. 6 illustrates a side-view of an arrow tracking device 600 according to an example embodiment. An arrow tracking device 600 may be the arrow tracking device 100 described in FIG. 1. As illustrated in FIG. 6, the arrow tracking device 600 may store the tracker 103 in a different location within the hollow shaft 107 of the arrow tracking device 600. For example, the tracker 103 may be located toward the tip of the arrow having different screw on heads. In one exemplary embodiment, FIG. 6 shows that the tracker 103 may be located within a center of the hollow shaft 107 of the arrow tracking device 600. Embedding the tracker 103 within the center of the arrow tracking device 600 may provide a benefit of preventing damage to the tracker 103 in the event one of the ends of the error tracking device 600 becomes damaged. The arrow tracking device 600 may also have a plastic floatation device 601 which may slide along the hollow shaft 107 of the arrow tracking device 600.

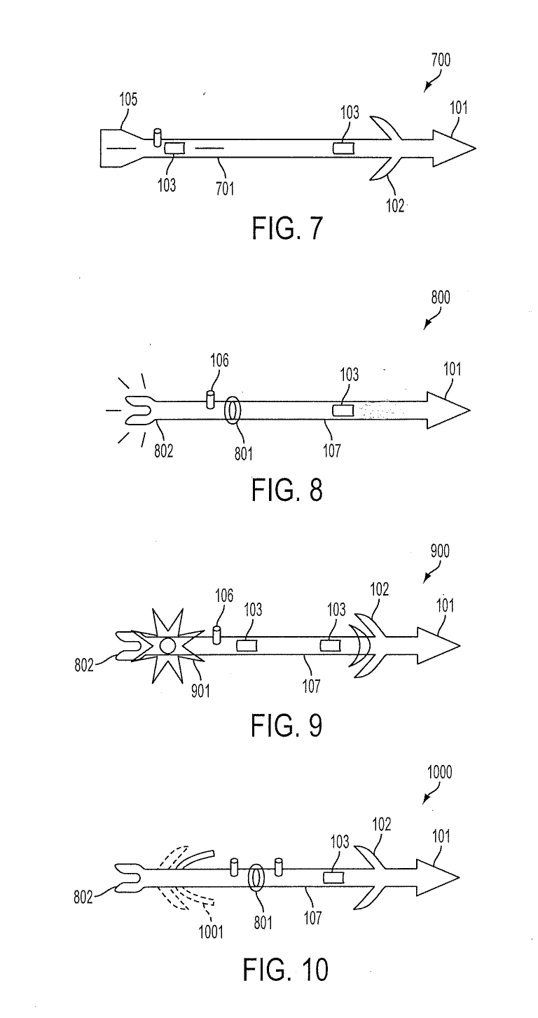

FIG. 7 illustrates a side-view 700 of an arrow tracking device according to an example embodiment. An arrow tracking device 700 may be the arrow tracking device 100 described in FIG. 1. FIG. 7 shows that the tracker 103 may be located in a rear position of the arrow tracking device 700, for example, near the fletches 105. This configuration may further protect the tracker 103 from being damaged upon impact of the arrow tracking device 700. Additionally, the arrow tracking device 700 may have metal barbs 701 which are spring loaded or may be held down flush to the shaft by a floating plastic donut ring (not shown).

FIG. 8 illustrates a side-view of the arrow tracking device 800 according to an example embodiment. An arrow tracking device 800 may be the arrow tracking device 100 described in FIG. 1. FIG. 8 shows that the arrow tracking device 800 may have a circular nylon spacer 801 and a lighted nock 802. The lighted nock 802 may serve to keep the arrow in place on the string as the bow is being drawn. The lighted nock 802 may be illuminated to provide visibility in the dark. In one embodiment, the lighted nock 802 may be simple slots cut in a back end of an arrow, or separate pieces made from wood, plastic, or horn that are then attached to the end of the arrow tracking device 800. The circular nylon spacer 801 encircles the arrow. The battery 202 may be used to power and illuminate the lighted nock 802.

FIG. 9 illustrates a side-view of the arrow tracking device 900 according to an example embodiment. An arrow tracking device 900 may be the arrow tracking device 100 described in FIG. 1. FIG. 9 shows that the arrow tracking device 900 may have mirror rosettes 901 which encircle the arrow. Additionally, the mirror rosettes 901 may glide back and forth on the rear end of the arrow tracking device 900 between a stopper 106 and a lighted nock 802. In an alternative embodiment. FIG. 9 may have a safety slide (not shown) which is positioned toward the end of the arrow having the screw-on head 101. The safety slide is designed to prevent snap-back of an arrow by keeping a bow string forward. In an exemplary embodiment, the arrow tracking device may have more than one tracker 103 device embedded in the hollow shaft 107. Additionally, multiple trackers 103 may be embedded into the arrow tracking device 900. This may provide a benefit of still being able to track the arrow tracking device 900 in case one of the trackers 103 becomes damaged. In one embodiment, a tracker 103 may be embedded in the middle of the hollow shaft 107 and another tracker 103 may be embedded closer to the screw-on head 101. In alternative embodiments, multiple trackers 103 may be placed in various positions throughout the hollow shaft 107.

FIG. 10 illustrates a side-view of the arrow tracking device 1000 according to an example embodiment. An arrow tracking device 1000 may be the arrow tracking device 100 described in FIG. 1. FIG. 10 shows an “S” nock 1001 which is located on a rear end of the arrow tracking device 1000 opposite from the screw-on head 101. The “S” nock 1001 may be foldable to be flush with the hollow shaft 107 and fold in and out from the hollow shaft 107.

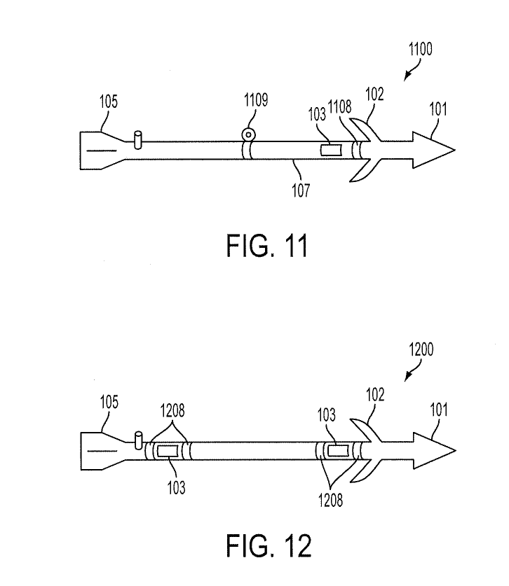

FIG. 11. illustrates a side-view of an arrow tracking device 1100, according to an exemplary embodiment. An arrow tracking device 1100 may be the arrow tracking device 100 described in FIG. 1. In an alternative embodiment, the arrow tracking device 1100 may include a stabilizer 1108 positioned behind the first set of metal barbs 102. The stabilizer 1108 may be used to prevent the tracker 103 from moving in the hollow shaft 107 of the arrow tracking device 1100 during impact. The stabilizer 1108 may be used to dissipate kinetic energy produced by flight of the arrow tracking device 1100 on the tracker 103. Any lightweight, impact absorbing material may be used for the stabilizer 1108 including but not limited to foam, rubber, polymers or any other shock absorbing material. In an example embodiment, the stabilizer 1108 may be positioned horizontally in the hollow shaft 107. In another embodiment, the stabilizer 1108 may be positioned vertically in the hollow shaft 107. In an alternative embodiment, the stabilizer 108 may act as a cover for the tracker 103, encompassing the tracker 103 within the hollow shaft 107.

The arrow tracking device 1100 may also include a camera device 1109, attached to the hollow shaft 107 of the arrow tracking device 1100. The camera device 1109 may be any device capable of producing video data. In one embodiment, the camera device 1109 may also produce photo image data including still photos of the arrow tracking device 1100 at various points in time. The camera device 1109 may be able to communicate wirelessly with a computer or portable device having a processor. One example of use of a camera device 1109 may be to illustrate the path of the arrow tracking device 1100 during flight.

The camera device 1109 may also be used to show the physical area surrounding the arrow tracking device 1100 so that the location of the arrow tracking device 1100 may be more easily perceived. For example, if the arrow tracking device 1100 is stuck in a tree trunk, a hunter can visually identify this through use of the camera device 1109 wirelessly communicating with a computer or portable device having a processor. Thus, a hunter may be able to readily locate the arrow tracking device 1100 without searching around a location as a visual identification can be confirmed.

The camera device 1109 may be attached to any portion of the arrow tracking device 1100. In one example embodiment, the camera device 1109 may be attached to the center of the hollow shaft 107 of the arrow tracking device 1100. In another embodiment, the camera device 1109 may be attached to the rear of the arrow tracking device 1100 near the fletches 105. In an exemplary embodiment, the camera device 1109 is made from a strong, lightweight material, including but not limited to composite laminates, plastics, carbon fiber reinforced plastic, and alloys including magnesium-aluminum, among others. In one example embodiment, the camera device 1109 may be able to rotate. This may provide a hunter with a more realistic picture of a location surrounding the arrow tracking device 1100. A computer application running on the computer or portable device may be used to control rotation of the camera device 1109 and display feedback to a user.

FIG. 12. illustrates a side-view of an arrow tracking device 1200, according to an exemplary embodiment. An arrow tracking device 1200 may be the arrow tracking device 100 described in FIG. 1. In this example embodiment, multiple stabilizers 1208 may be used to secure the tracker 103, including one in front of the tracker 103 and one behind it. Additionally, multiple trackers 103 may be embedded into the arrow tracking device 1200. This may provide a benefit of still being able to track the arrow tracking device 1200 in case one of the trackers 103 becomes damaged. Additional stabilizers 1208 may be used to protect the multiple trackers 103 during impact.

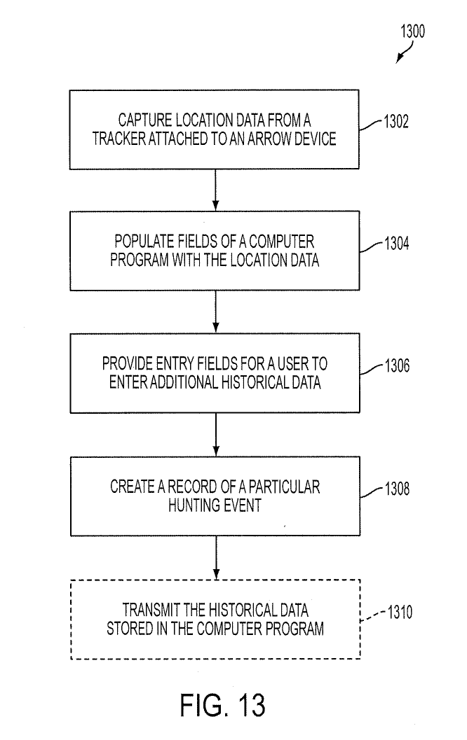

FIG. 13 illustrates a method 1300 of capturing and storing arrow information according to an exemplary embodiment. As described above, arrow information may include location data and historical data. Location data includes data obtained by a tracker 103 embedded in an arrow tracking device 100 (as described in FIG. 1). The historical data may be used to recount a particular hunting event including use of the location data provided by the tracker 103 of the arrow tracking device 100. For example, a father may take his son hunting for a first time and desire to document the experience. The method 1300 may comprise capturing location data from a tracker attached to an arrow device (block 1302), populating fields of a computer program with the location data (block 1304), providing entry fields for a user to enter additional historical data to recount a particular hunting event (block 1306), and creating a record of the particular hunting event (block 1308).

At block 1302, location data may be captured. A computer or portable device having a processor may be used to capture and store historical data from tracker 103 attached to an arrow device. The tracker 103 of the arrow tracking device 100 may communicated wirelessly with the computer or portable device having a processor.

At block 1304, fields of a computer program are populated with the location data. A computer program/application may be accessed using the computer or portable device which receives the location data from a tracker 103 of an arrow tracking device. Information such as location including coordinates of a hunting event as well as date and time may be populated in the computer program/application using the location data. Additional information such as weather conditions including temperature may also be populated in the computer program/application using the location data of the tracker 103 or a satellite device connected with the computer or portable device. In an example embodiment, the computer program/application may generate a map to illustrate a graphical representation of the location data. In an exemplary embodiment, the computer program or application may capture and store the location data information in a computer program without user entry.

At block 1306, additional entry fields are provided for a user. A user may utilize a computer program or an application to enter and store historical data. Additional fields of historical data may be entered by a user to fully recount a particular hunting event via the computer or portable device. The fields of historical data that may be entered include but are not limited to names of hunters, ages, types of game hunted size and weight of the game, type of bow/arrow used, as well as additional miscellaneous note entry fields. The computer program may also provide the ability to attach image and video data of a hunting event, including a particular hunting event using the arrow tracking device 100.

In an alternative embodiment, historical data may also include hunting documentation data such as images of hunting licenses or permits. This historical data can be accessed by the computer program on command by a user and indicate that a particular hunting event was authorized. This may also provide the benefit of not requiring a hunter to carry a physical documentation including a license or permit and also help to provide a more complete recounting of a particular hunting event.

At block 1308, a record of a particular hunting event is created by the computer program. In one embodiment, the record may be created after the user has entered all of the data that it wants to appear in the record. The computer or portable device may further be used to display the record of a particular hunting event. In an exemplary alternative embodiment the computer program may post and/or transmit any or all of the historical data in the computer program (block 1310). For instance, evidence of hunting documentation may be transferrable to a state hunting authority or the historical data entered by a user may be posted or transferred to another user as evidence of a particular hunting event. In one embodiment, the computer program may allow other users to comment on historical data posted or transferred by a user. Alternatively, the record may also be presented in a variety of different representations including but not limited to graphical representations, image representations, video representations and voice representations, among others. The record may include video or photo data provided by a camera device such as the camera device 1109 described in FIG. 11. This may provide real-time footage or images of a hunting event.

Additional example embodiments of the arrow tracking device 100 may include a lighted nock 802 manufactured by Firenock LLC, for example, Aerovane™ and Aerovane II™.

Further example embodiments may include the arrow tracking device 100 having an IllumAnight produced by the Shannon Hunt Group which fits on the arrow and assists in tracking game after being shot.

Even further example embodiments of an arrow tracking device may include a tracker 103 which may be a GSM/GPRS GPS tracking device.

The methods described above may also be implemented through computer readable code/instructions stored in/on a medium, e.g., a computer readable medium, to control at least one processing element to implement any above described embodiment. The medium can correspond to a non-transitory medium/media permitting the storing or transmission of the computer readable code. The computer readable medium may also be embodied in at least one application specific integrated circuit (ASIC) or Field Programmable Gate Array (FPGA).

The computer readable code can be recorded or transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media. The media may also be a distributed network, so that the computer readable code is stored or transferred and executed in a distributed fashion. Still further, as only an example, the processing element could include at least one processor or at least one computer processor, and processing elements may be distributed or included in a single device.

In addition to the above described embodiments, example embodiments can also be implemented as hardware, e.g., at least one hardware based processing unit including at least one processor capable of implementing any above described embodiment. The described hardware devices may be configured to act as one or more software modules in order to perform the operations of the above-described exemplary embodiments, or vice-versa.

Although embodiments have been shown and described, it should be appreciated by those skilled in the art that changes may be made in these embodiments without departing from the principles and spirit of the disclosure, the scope of which is defined in the claims and their equivalents.

What is claimed is:

1. A device, comprising:
an arrow having a tip, a shaft and an end, the shaft having a tracker embedded therein to track at least one position of the arrow.

2. The device of claim 1, comprising at least one set of barbs attached to the shaft, and fletches attached to the end of the arrow.

3. The device of claim 1, wherein the tracker is a radio pulse device.

4. The device of claim 1, wherein the tracker is a global positioning system (GPS) or GPS chip.

5. The device of claim 4, wherein the receiver receives GPS data including a current location including a latitude, longitude and altitude of the arrow and the transmitter transmits the received GPS data over a network to a computer.

6. The device of claim 5, wherein the computer displays a view of the arrow responsive to the GPS data on a map.

7. The device of claim 1, wherein the computer sends a message indicating the current location of the arrow to a portable device.

8. The device of claim 1, wherein the arrow sends a message indicating the current location of the arrow to a portable device.

9. The device of claim 7, wherein the portable device displays the current location of the arrow on a map.

10. The device of claim 7, wherein the message includes a plurality of locations of the arrow since a predetermined time and the portable device displays a time-lapse view of the plurality of locations of the arrow.

11. The device of claim 7, wherein the message includes a current underwater depth of the arrow and underwater environmental surroundings of the arrow and the portable device displays the current underwater depth and underwater environmental surroundings of the arrow.

12. The device of claim 8, wherein the portable device calculates a distance from the portable device to the arrow based on the current position of the portable device and the current position of the arrow and displays directions to the arrow on a map on the portable device.

13. The device of claim 1, wherein the shaft of the arrow includes at least one stabilizer embedded in the shaft.

14. The device of claim 1, wherein the arrow includes a nylon spacer and a lighted nock.

15. The device of claim 1, wherein the arrow comprises a camera device attached to the shaft of the arrow.

16. The device of claim 1, wherein the shaft of the arrow comprises a locking device, allowing a length of an arrow to be adjusted and locked for use.

17. A method, comprising:
receiving, by a computer, a plurality of locations, including a current location, of an arrow, the arrow including a tracker embedded in a shaft of the arrow;
storing, by the computer, the plurality of locations of the arrow in a storage; and
displaying, by the computer, the current location of the arrow on a display.

18. The method of claim 17, comprising storing historical information relating to at least one location of the plurality of locations to recount a hunting event.

19. A computer readable medium to control a computer, storing a program which causes the computer to execute a process, comprising:
receiving a location of an arrow having a tracker embedded in the arrow;
storing the location of the arrow in a storage; and
displaying the location of the arrow on a display.

20. The computer readable medium of claim 19, comprising storing historical information relating to at least one location of the plurality of locations to recount a hunting event.
